(19) United States
(12) Patent Application Publication
(10) Pub. No.: US 2024/0031754 A1
(43) Pub. Date: Jan. 25, 2024

(54) MANUFACTURING METHOD OF MICRO-ELECTROMECHANICAL SYSTEM ACOUSTIC SENSOR

(71) Applicant: National Kaohsiung University of Science and Technology, Kaohsiung City (TW)

(72) Inventor: CHENG-TA YANG, Kaohsiung City (TW)

(21) Appl. No.: 18/209,512

(22) Filed: Jun. 14, 2023

(30) Foreign Application Priority Data
Jul. 19, 2022 (TW) 111127040

(51) Int. Cl. H04R 31/00

(52) U.S. Cl. CPC H04R 31/00; H04R 2201/003

(57) ABSTRACT

A manufacturing method of a micro-electromechanical system acoustic sensor includes: forming an insulating layer and two first electrodes on a base plate, the two first electrodes being spaced apart from each other; arranging a first sacrificial layer on the insulating layer and the two first electrodes, and forming at least one first recess in the first sacrificial layer respectively above the two first electrodes; arranging a second sacrificial layer on the first sacrificial layer and the at least two first recesses, forming two second recesses spaced apart in the second sacrificial layer, and making the two second recesses respectively communicate with the corresponding at least one first recess to form two recess spaces; filling the two recess spaces respectively with a material to form two second electrodes; and removing all the first sacrificial layer and the second sacrificial layer.

### CROSS-REFERENCE TO RELATED APPLICATION

This application claims the benefit of Taiwan Patent Application No. 111127040, filed on 19 Jul. 2022, which is hereby incorporated by reference for all purposes as if fully set forth herein.

### BACKGROUND

### Technical Field

The present invention mainly relates to a manufacturing method of a micro- electromechanical system acoustic sensor, and particularly to a manufacturing method of a micro-electromechanical system acoustic sensor applied to the field of acoustics.

### Related Art

There are various types of microphones, such as dynamic microphones, condenser microphones, ribbon microphones and carbon microphones. In addition, in mobile devices such as mobile phones, electret (ECM) condenser microphones and micro-electromechanical system (MEMS) microphones are the most common. The micro-electromechanical systems are used for manufacturing miniaturized mechanical elements by using a semiconductor process, and can be used for manufacturing microphones by semiconductor techniques such as deposition, exposure, development and selective etching of material layers.

FIG. 1A to FIG. 1F are schematic views of a conventional manufacturing method of an acoustic sensor for microphones. The method may sequentially include a plurality of complicated steps such as a contact pad step, a first air-gap oxide step, a second air-gap oxide step, a polysilicon backplate step, a metal step and a backside diaphragm step.

Specifically, in the contact pad step, a base plate 91 is provided, and an insulating layer 92 and an electrode 93 are formed on the base plate 91. Next, in the first air-gap oxide step and the second air-gap oxide step, a first oxide layer 94 and a second oxide layer 95 are respectively generated. Then, in the polysilicon backplate step, a polysilicon backplate layer 96 is formed on the second oxide layer 95, and in the metal step, a first metal layer 97 is formed on the polysilicon backplate layer 96.

Referring to FIG. 1E, in the metal step, a plurality of vias H is respectively formed in the polysilicon backplate layer 96 and the first metal layer 97, and an etching solution is poured into the plurality of vias H, so as to etch the first oxide layer 94 and the second oxide layer 95.

However, since the openings of the plurality of vias H typically have small sizes, it may be difficult for the etching solution to flow in and out of the vias, causing insufficient etching of the first oxide layer 94 and the second oxide layer 95, and leading to connection between the polysilicon backplate layer 96 and the electrode 93; or causing excessive etching to the insulating layer 92 and the electrode 93, or even causing the electrode 93 to break during use due to insufficient thickness caused by excessive etching. Thereby, the above conventional manufacturing method of the acoustic sensor for microphones is prone to poor etching accuracy control, complicated steps and poor yield of finished products.

In view of this, it is necessary to provide a manufacturing method of a micro-electromechanical system acoustic sensor to solve the above problems.

### SUMMARY

An objective of the present invention is to provide a manufacturing method of a micro-electromechanical system acoustic sensor. The method can simplify the manufacturing process and improve the manufacturing yield.

In order to achieve the above objective, the present invention is directed to a manufacturing method of a micro-electromechanical system acoustic sensor, comprising: providing a base plate; forming at least one insulating layer on the base plate; forming two first electrodes on the at least one insulating layer, the two first electrodes being spaced apart from each other; arranging a first sacrificial layer on the insulating layer and the two first electrodes, and forming at least one first recess in the first sacrificial layer respectively above the two first electrodes, the at least two first recesses respectively exposing at least a part of a top surface of the two first electrodes; arranging a second sacrificial layer on the first sacrificial layer and the at least two first recesses, forming two second recesses spaced apart in the second sacrificial layer, and making the two second recesses respectively communicate with the corresponding at least one first recess to form two recess spaces; filling the two recess spaces respectively with a material to form two second electrodes; and removing all the first sacrificial layer and the second sacrificial layer, and forming an acoustic flow channel between the two first electrodes and the two second electrodes.

In some embodiments, the base plate comprises a silicon base layer, and a material of the silicon base layer is silicon, silicon-germanium, silicon carbide, a glass substrate or a III-V compound semiconductor.

In some embodiments, the first sacrificial layer and the second sacrificial layer respectively comprise silicon nitride, silicon oxide and a thick photoresist.

In some embodiments, the insulating layer is made of silicon oxide, silicon nitride, silicon oxynitride, a low dielectric constant material with a dielectric constant of 2.5 to 3.9, or an ultralow dielectric constant material with a dielectric constant of less than 2.5.

In some embodiments, the two first electrodes are made of metals such as gold, nickel, platinum, palladium, iridium, titanium, chromium, tungsten, aluminum and copper, metal compounds or ion-doped semiconductor materials.

In some embodiments, the material for forming the two second electrodes is an electrically charged polymer or a conductive polymer.

In some embodiments, the two second electrodes are formed by electroforming, injection molding or 3D (three-dimensional) printing.

In some embodiments, the two second recesses are made respectively communicate with the corresponding at least one first recess by over-etching to form the two recess spaces.

In some embodiments, an etching manner for over-etching and removing all the first sacrificial layer and the second sacrificial layer is a dry etching process or a wet etching process.

In some embodiments, all side walls forming the two recess spaces are respectively perpendicular to the insulating layer.

In some embodiments, side walls forming the two recess spaces and facing the acoustic flow channel are respectively perpendicular to the insulating layer, side walls forming the two recess spaces and facing away from the acoustic flow channel respectively form a diverging first cambered surface along an acoustic flow direction of the acoustic flow channel and then continuously extend from a surface of the first cambered surface to form a converging second cambered surface, and after removing all the first sacrificial layer and the second sacrificial layer, the two second electrodes in a wing shape are formed.

The manufacturing method of a micro-electromechanical system acoustic sensor of the present invention has the following characteristics: in the above etching process, an etching solution is used to remove all the first sacrificial layer and the second sacrificial layer, so that the etching solution can flow in and out easily and will not reside. Further, the thickness of the first sacrificial layer and the second sacrificial layer may be adjusted in advance, so that after the etching process is performed, the second electrode will not easily break due to insufficient thickness caused by excessive etching. Thereby, the manufacturing method of a micro-electromechanical system acoustic sensor of the present invention can simplify the steps of the manufacturing method and prolong the service life of the finished product.

### BRIEF DESCRIPTION OF THE DRAWINGS

FIG. 1A to FIG. 1F are side sectional views of a conventional manufacturing method of an acoustic sensor for microphones;

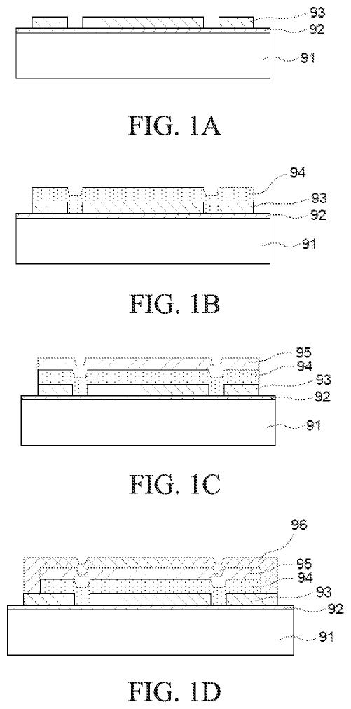

FIG. 2A, FIG. 2D, FIG. 2G, FIG. 2I and FIG. 2K are side sectional views of a manufacturing method of a micro-electromechanical system acoustic sensor according to the present invention;

FIG. 2B, FIG. 2E, FIG. 2H, FIG. 2J and FIG. 2L are front sectional views of the manufacturing method of a micro-electromechanical system acoustic sensor according to the present invention;

FIG. 2C is a three-dimensional view of covering a first sacrificial layer with a first mask in the manufacturing method of a micro-electromechanical system acoustic sensor according to the present invention;

FIG. 2F is a three-dimensional view of covering a second sacrificial layer with a second mask in the manufacturing method of a micro-electromechanical system acoustic sensor according to the present invention; and

FIG. 2M is a three-dimensional view of a manufacturing method of a micro-electromechanical system acoustic sensor according to another embodiment of the present invention.

### DETAILED DESCRIPTION

Embodiments of the present invention are described in detail below with reference to the accompanying drawings. The accompanying drawings are mainly simplified schematic views, and only illustrate the basic structure of the present invention in a schematic way. Therefore, only the elements related to the present invention are marked in the drawings, and the elements shown are not drawn with the number, shape and dimension scale during the implementation. The specifications and sizes in the actual implementation are actually an optional design, and the layout of the elements may be more complicated.

The following embodiments are described with reference to the accompanying drawings to exemplify particular embodiments of the present invention. The directional terms mentioned in the present invention, such as “up”, “down”, “front”, “back” and the like are merely directions with reference to the accompanying drawings. Therefore, the directional terms used are used for illustrating and understanding the present application, and are not intended to limit the present application. In addition, in the specification, unless explicitly described to the contrary, the word “include” will be understood to mean including the element described, but not excluding any other element.

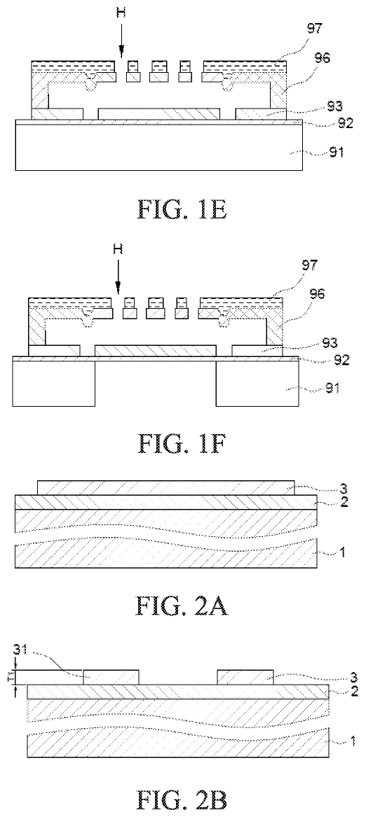

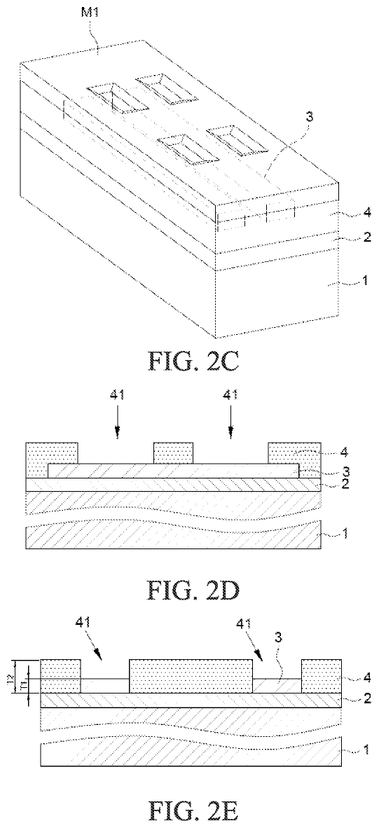

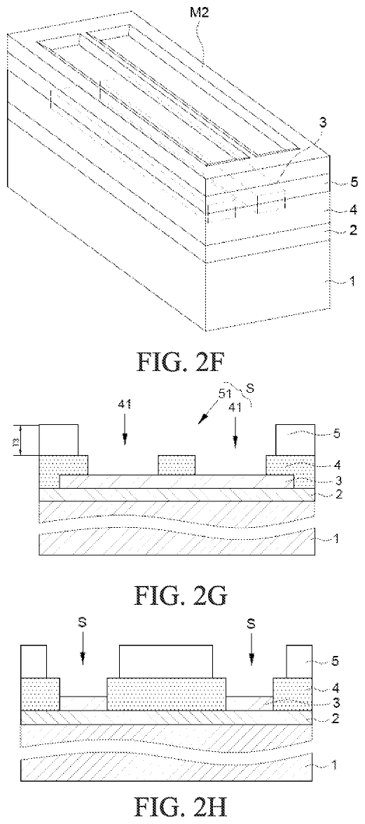

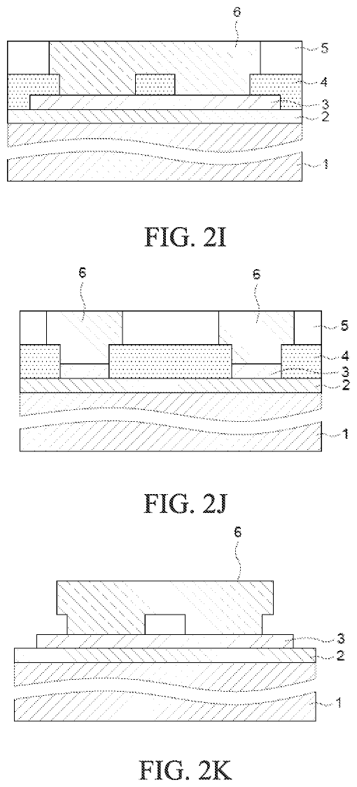

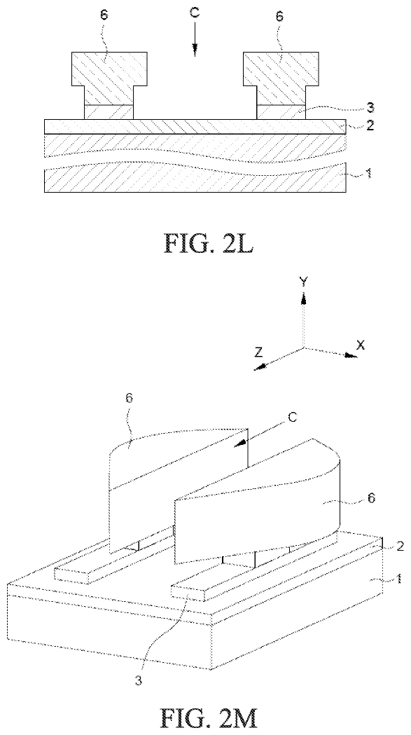

FIG. 2A to FIG. 2M show a preferred embodiment of a manufacturing method of a micro-electromechanical system acoustic sensor of the present invention.

As shown in FIG. 2A and FIG. 2B, a base plate 1 is provided. In the present embodiment, a thickness of the base plate 1 is in a range of 400 micrometer (μm) to 500 μm, but is not limited thereto.

Specifically, the base plate 1 includes a silicon base layer, and a material of the

silicon base layer may be silicon (Si), silicon-germanium (SiGe), silicon carbide (SiC), a glass substrate or a III-V compound semiconductor, such as gallium nitride (GaN) and gallium arsenide (GaAs).

At least one insulating layer 2 is formed on the base plate 1. In the present embodiment, a quantity of the insulating layers 2 is one, and a thickness of the insulating layer 2 is in a range of 300 nanometer (nm) to 600 nm, but is not limited thereto. The insulating layer 2 may be formed by silicon oxide, silicon nitride, silicon oxynitride or other dielectric materials. The dielectric material may be a low dielectric constant material (with a dielectric constant of 2.5 to 3.9) or an ultralow dielectric constant material (with a dielectric constant of less than 2.5).

Specifically, the insulating layer 2 may be deposited on the base plate 1 by a deposition process. The deposition process may be atomic layer deposition (ALD), chemical vapor deposition (CVD), plasma enhanced chemical vapor deposition (PECVD), molecular beam epitaxy (MBE) or liquid-phase epitaxy (LPE), but is not limited thereto.

Referring to FIG. 2B, two first electrodes 3 are formed on the at least one insulating layer 2. The two first electrodes 3 are spaced apart from each other and each have a first thickness T1. In the present embodiment, the first thickness T1 may be in a range of 300 nm to 600 nm, but the present invention is not limited thereto.

Specifically, the first electrodes 3 may be made of metals such as gold (Au), nickel (Ni), platinum (Pt), palladium (Pd), iridium (Ir), titanium (Ti), chromium (Cr), tungsten (W), aluminum (Al) and copper (Cu), metal compounds or ion-doped semiconductor materials, but are not limited thereto.

Further, a conductive material layer may be formed on the at least one insulating layer 2 by evaporation, sputtering, chemical vapor deposition (CVD), physical vapor deposition (PVD), electroplating, electroforming or atomic layer deposition.

Next, a patterning process is performed on the conductive material layer. For example, photolithography may be used: a photoresist is coated on a surface of the conductive material layer, and then masking, exposure, development and etching are performed to form the two first electrodes 3. The conductive material layer may be etched by a dry etching process or a wet etching process. For example, the dry etching process may be inductively coupled plasma etching (ICP), reactive ion etching (RIE), neutral beam etching (NBE) or electron cyclotron resonance etching (ECR), but the present invention is not limited thereto.

Referring to FIG. 2E, a first sacrificial layer 4 is arranged on the insulating layer 2 and the two first electrodes 3. The first sacrificial layer 4 has a second thickness T2. In the present embodiment, the first sacrificial layer 4 may include semiconductor materials such as silicon nitride, silicon oxide and a thick photoresist. The second thickness T2 may be in a range of 1 μm to 10 μm, but is not limited thereto.

Referring to FIG. 2C and FIG. 2D, in the present embodiment, after the

arrangement of the first sacrificial layer 4 is completed, the first sacrificial layer 4 may be directly coated with the photoresist (not shown) and then covered with a first mask M1. After exposure and development, the photoresist at positions for respectively forming at least one first recess 41 above the two first electrodes 3 is removed, and the above etching process is performed on the first sacrificial layer 4. Then, the remaining photoresist is removed, such that the at least one first recess 41 is formed in the first sacrificial layer 4 respectively above the two first electrodes 3, and at least a part of a top surface of the corresponding first electrode 3 is exposed.

Further, results of performing the patterning process on the first sacrificial layer 4 may be as shown in FIG. 2D and FIG. 2E. A quantity of the first recesses 41 located above each first electrode 3 is two, but is not limited thereto.

Referring to FIG. 2F, FIG. 2G and FIG. 2H, a second sacrificial layer 5 is arranged on the first sacrificial layer 4 and the at least two first recesses 41, two second recesses 51 spaced apart are formed in the second sacrificial layer 5, and the two second recesses 51 are made respectively communicate with the corresponding at least one first recess 41 to form two recess spaces S. The second sacrificial layer 5 has a third thickness T3. In the present embodiment, the second sacrificial layer 5 may also include semiconductor materials such as silicon nitride, silicon oxide and a thick photoresist. The third thickness T3 may be in a range of 5 μm to 10 μm, but is not limited thereto. Further, all side walls forming the two recess spaces S may be substantially perpendicular to the insulating layer 2.

Specifically, during the arrangement of the second sacrificial layer 5, a part of the second sacrificial layer 5 may fill the at least two first recesses 41. Then, the second sacrificial layer 5 may be directly coated with a photoresist and then covered with a second mask M2. Further, after development, the photoresist at positions for forming the two second recesses 51 is removed, and the above etching process is performed to form the two second recesses 51. Finally, the positions where the two second recesses 51 are arranged are etched by over-etching, such that the at least two first recesses 41 respectively communicate with the corresponding second recesses 51 to form the two recess spaces S. It is worth noting that results of performing the patterning process on the second sacrificial layer 5 may be as shown in FIG. 2G and FIG. 2H.

It is worth noting that in other embodiments, after the thickness of the first sacrificial layer 4 is adjusted, only the first sacrificial layer 4 is formed, and the two second recesses 51 and the at least two first recesses 41 are sequentially formed with the second mask M2 and the first mask M1, so as to form the two recess spaces S. In other words, it is unnecessary to form the second sacrificial layer 5 additionally.

Referring to FIG. 2I and FIG. 2J, the two recess spaces S may be respectively filled with a material for forming electrodes by evaporation, sputtering, electroplating, electroforming, injection molding or 3D printing to form two second electrodes 6. In the present embodiment, the material for forming the two second electrodes 6 may be made of metals such as gold (Au), nickel (Ni), platinum (Pt), palladium (Pd), iridium (Ir), titanium (Ti), chromium (Cr), tungsten (W), aluminum (Al) and copper (Cu), metal compounds, ion-doped semiconductor materials or other conductive materials, and may also be an electrically charged polymer (e.g., electret) or a conductive polymer, but is not limited thereto.

Referring to FIG. 2K and FIG. 2L, all the first sacrificial layer 4 and the second sacrificial layer 5 are removed by the above etching process, and an acoustic flow channel C is formed between the two first electrodes 3 and the two second electrodes 6. The acoustic flow channel C is used as a position where a sound hole of a microphone is arranged. Thereby, the manufacturing of the micro-electromechanical system acoustic sensor of the present invention is completed.

It is worth noting that in the manufacturing method of a micro-electromechanical system acoustic sensor of the present invention, when forming the first electrodes 3, the first sacrificial layer 4 and the second sacrificial layer 5, one mask is used respectively. That is, in the present embodiment, at least three masks are used in total. Therefore, the manufacturing method has the advantages of fewer masks, fewer process steps and higher process yield.

Referring to FIG. 2M, in another embodiment, side walls forming the two recess spaces S and facing the acoustic flow channel C may be substantially perpendicular to the insulating layer 2, and side walls forming the two recess spaces S and facing away from the acoustic flow channel C may respectively form a diverging first cambered surface along an acoustic flow direction Z of the acoustic flow channel C and then continuously extend from a surface of the first cambered surface to form a converging second cambered surface. Thereby, the two recess spaces S are respectively filled with the material for forming the electrodes, and after removing all the first sacrificial layer 4 and the second sacrificial layer the two second electrodes 6 in a wing shape are formed. In this way, the second electrodes 6 each have a higher air flow speed and a lower pressure on an outer surface than on an inner surface, so that the two second electrodes 6 can wobble relatively, thereby improving the sensitivity and directionality of the finished product of the micro-electromechanical system acoustic sensor.

Based on the above, according to the manufacturing method of a micro-electromechanical system acoustic sensor of the present invention, in the above etching process, an etching solution is used to remove all the first sacrificial layer and the second sacrificial layer, so that the etching solution can flow in and out easily and will not reside. Further, the thickness of the first sacrificial layer and the second sacrificial layer may be adjusted in advance, so that after the etching process is performed, the second electrode will not easily break due to insufficient thickness caused by excessive etching. Thereby, the manufacturing method of a micro-electromechanical system acoustic sensor of the present invention can simplify the steps of the manufacturing method and prolong the service life of the finished product.

The implementations disclosed above are merely illustrative of the principles, features and effects of the present invention, and are not intended to limit the scope of the present invention. Any person skilled in the art can modify and change the above implementations without departing from the spirit and scope of the present invention. Any equivalent changes and modifications made by using the disclosure of the present invention shall be subjected to the appended claims.

What is claimed is:

1. A manufacturing method of a micro-electromechanical system acoustic sensor, comprising:
providing a base plate;
forming at least one insulating layer on the base plate;
forming two first electrodes on the at least one insulating layer, the two first electrodes being spaced apart from each other;
arranging a first sacrificial layer on the insulating layer and the two first electrodes, and forming at least one first recess in the first sacrificial layer respectively above the two first electrodes, the at least two first recesses respectively exposing at least a part of a top surface of the two first electrodes;
arranging a second sacrificial layer on the first sacrificial layer and the at least two first recesses, forming two second recesses spaced apart in the second sacrificial layer, and making the two second recesses respectively communicate with the corresponding at least one first recess to form two recess spaces;
filling the two recess spaces respectively with a material to form two second electrodes; and
removing all the first sacrificial layer and the second sacrificial layer, and forming an acoustic flow channel between the two first electrodes and the two second electrodes.

2. The manufacturing method of claim 1, wherein the base plate comprises a silicon base layer, and a material of the silicon base layer is silicon, silicon-germanium, silicon carbide, a glass substrate or a III-V compound semiconductor.

3. The manufacturing method of claim 1, wherein the first sacrificial layer and the second sacrificial layer respectively comprise silicon nitride, silicon oxide and a thick photoresist.

4. The manufacturing method of claim 1, wherein the insulating layer is made of silicon oxide, silicon nitride, silicon oxynitride, a low dielectric constant material with a dielectric constant of 2.5 to 3.9, or an ultralow dielectric constant material with a dielectric constant of less than 2.5.

5. The manufacturing method of claim 1, wherein the two first electrodes are made of metals such as gold, nickel, platinum, palladium, iridium, titanium, chromium, tungsten, aluminum and copper, metal compounds or ion-doped semiconductor materials.

6. The manufacturing method of claim 1, wherein the material for forming the two second electrodes is an electrically charged polymer or a conductive polymer.

7. The manufacturing method of claim 1, wherein the two second electrodes are formed by electroforming, injection molding or 3D (three-dimensional) printing.

8. The manufacturing method of claim 1, wherein the two second recesses are made respectively communicate with the corresponding at least one first recess by over-etching to form the two recess spaces.

9. The manufacturing method of claim 8, wherein an etching manner for over-etching and removing all the first sacrificial layer and the second sacrificial layer is a dry etching process or a wet etching process.

10. The manufacturing method of claim 1, wherein all side walls forming the two recess spaces are respectively perpendicular to the insulating layer.

11. The manufacturing method of claim 1, wherein side walls forming the two recess spaces and facing the acoustic flow channel are respectively perpendicular to the insulating layer, side walls forming the two recess spaces and facing away from the acoustic flow channel respectively form a diverging first cambered surface along an acoustic flow direction of the acoustic flow channel and then continuously extend from a surface of the first cambered surface to form a converging second cambered surface, and after removing all the first sacrificial layer and the second sacrificial layer, the two second electrodes in a wing shape are formed.
